(19) United States
(12) Patent Application Publication
(10) Pub. No.: US 2008/0209399 A1
(43) Pub. Date: Aug. 28, 2008

(54) METHODS AND SYSTEMS FOR TRACKING AND AUDITING INTELLECTUAL PROPERTY IN PACKAGES OF OPEN SOURCE SOFTWARE

(76) Inventors: Michael Bonnet, Boston, MA (US); William Baroniunas, Apex, NC (US); Mark Webbink, Durham, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 11/679,787

(22) Filed: Feb. 27, 2007

(51) Int. Cl. G06F 9/44

(52) U.S. Cl. 717/122; 717/120

(57) ABSTRACT

Embodiments of the present invention provide a way to accurately track and audit the intellectual property aspects in software, such as packages or distributions of open source software. An intellectual property (IP) tool analyzes software as its source code is being submitted to a code repository or as a distribution of software is being built. The IP tool parses the source code and identifies various intellectual property aspects in the code, such as licenses, trademarks, patents, and the like. The IP tool then archives this information into a database and may also provide an output that indicates the results of this analysis. The analysis by the IP tool can be provided as meta-data with the software distribution or may be provided in the form of reports that are sorted and collated in various ways for the convenience of the user.

### DESCRIPTION OF THE INVENTION

1. Field of the Invention

The present invention relates to managing software, and more particularly, to tracking and auditing intellectual property features of software.

2. Background of the Invention

Open source software is software having source code that is available under a license permitting users to view and modify the software's source code, and to redistribute it in modified or unmodified form. Open source software is often developed in a public, collaborative manner, and typically, free or available for nominal cost. Because of these and other advantages, open source software has become a major trend in the software industry. Accordingly, it is now common for many companies to develop and use open source software.

However, although open source software is generally free, its use typically requires compliance with some form of license, such as the GNU General Public License (“GPL”). In addition, open source software may have other requirements, such as advertising requirements, trademark usage, etc., as part of its allowed use. Therefore, the uncontrolled use of open source can introduce risks, such as copyright infringement, breach of contract, patent infringement, trademark infringement, etc.

Accordingly, many companies attempt to conduct an audit or analysis of any open source software to ensure compliance with any licensing requirements or other intellectual property features. Unfortunately, existing processes for auditing software and tracking the various requirements for using open source software are difficult. Indeed, existing processes have been found to be almost completely ineffective at tracking code and intellectual property aspects of open source software. This is because open source software can be packaged and distributed in many different variations. In addition, open source software can include source code that is from a wide a variety of sources and organizations, each requiring their own set of intellectual property features.

Therefore, it would be desirable to provide methods and systems that could provide tracking and auditing of the intellectual property aspects in software.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIG. 1 illustrates an exemplary system configured to track intellectual property in packages of open source software;

FIG. 2 illustrates an architecture for an exemplary intellectual property tracking tool;

FIG. 3 illustrates a general process flow for tracking intellectual property in packages of open source software;

FIG. 4 illustrates a general process flow for auditing a package of open source software for intellectual property features; and

FIGS. 5-11 provide exemplary screen shots that may be presented by the intellectual property tracking tool.

### DESCRIPTION OF THE EMBODIMENTS

Embodiments of the present invention provide a way to accurately track and audit the intellectual property aspects in software, such as packages or distributions of open source software. In particular, embodiments of the present invention provide an intellectual property (IP) tool that analyzes software as its source code is being submitted to a code repository or as a distribution of software is being built. The IP tool parses the source code and identifies various intellectual property aspects in the code, such as licenses, trademarks, patents, and the like. The IP tool then archives this information into a database and may also provide an output that indicates the results of this analysis. The analysis by the IP tool can be provided as meta-data with the software distribution or may be provided in the form of reports that are sorted and collated in various ways for the convenience of the user.

Reference will now be made in detail to the exemplary embodiments of the invention, which are illustrated in the accompanying drawings. Wherever possible, the same reference numbers will be used throughout the drawings to refer to the same or like parts.

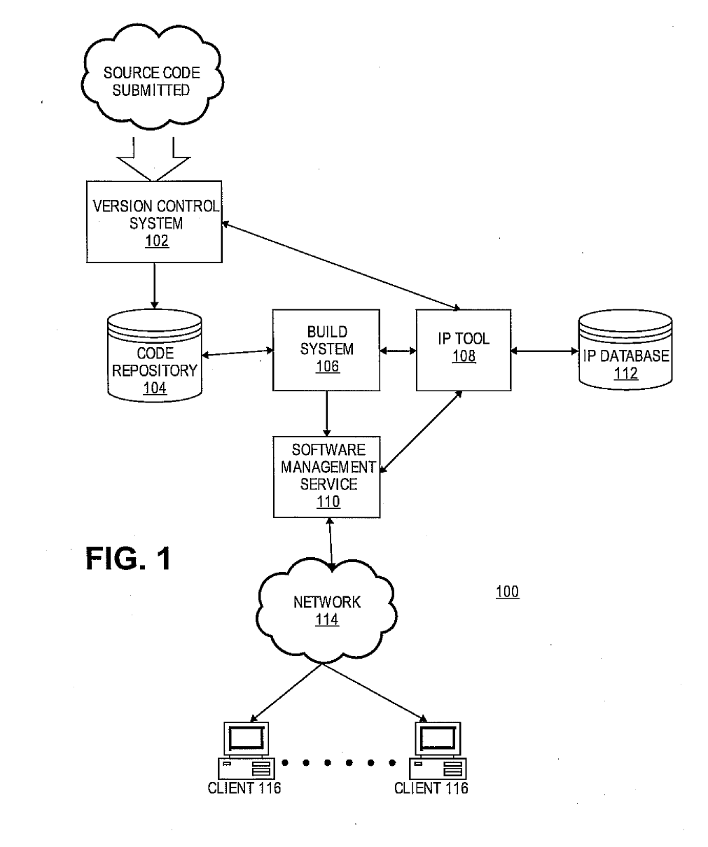

FIG. 1 illustrates an exemplary system 100 that is in accordance with embodiments of the present invention. As shown, system 100 may comprise a version control system 102, a code repository 104, a build system 106, an IP tool 108, a software management service 110, and an IP database 112. These components may be implemented using well known components of hardware, firmware, software, and the like.

Version control system 102 is a system that manages and archives submitted source code into code repository 104. For example, version control system 102 may be implemented as a Concurrent Versioning System (CVS), which is a well known open source version control system. Version control system 102 keeps track of all work and all changes in a set of files, typically the source code from a open source software project, and allows several developers to collaborate.

Version control system 102 may be implemented using a typical server running CVS software. In version control system 102, the server stores the current version(s) of the project and its history, and developers may connect to the server in order to check-out a complete copy of the project, work on this copy and then later check-in their changes. Typically, developers may connect to version control system 102 over a network, such as local area network or the Internet.

In some embodiments, version control system 102 may store multiple versions of files of source code in code repository 104. However, version control system 102 may accept changes to only the most recent version of a source code file. In addition, version control system 102 may allow for various queries. For example, version control system 102 may provide a comparison of different versions of files, provide a complete history of changes, or check-out a historical snapshot of the project as of a given date or as of a revision number. Version control system 102 may also developers to simply read and view various source code files. As noted, as developers update and/or commit to a source code file for release, the developer may submit an update or commit command to trigger version control system to archive that version in code repository 104.

Code repository 104 is a central place where source code files is stored and maintained. Code repository 104 also serves as the place from which code can be distributed over a network, such as network 114. In some embodiments, code repository 104 may employ various compression techniques, such as delta compression, to efficiently store the source code files. Code repository 104 may be implemented using well known components of hardware and software.

Build system 106 is a system that provides a suite of tools to assist in configuring and making various source code packages or distributions. For example, build system 106 may be implemented using the well known GNU build system software that is running on a general purpose server. Build system 106 may comprise various well known utilities to assist in configuring and building packages or distributions of software. For example, build system 106 may be implemented as a typical GNU build system, which comprises common utility programs, such as make, gettext, pkg-config, and the GNU Compiler Collection (GCC). As noted, these tools and programs are well known to those skilled in the art.

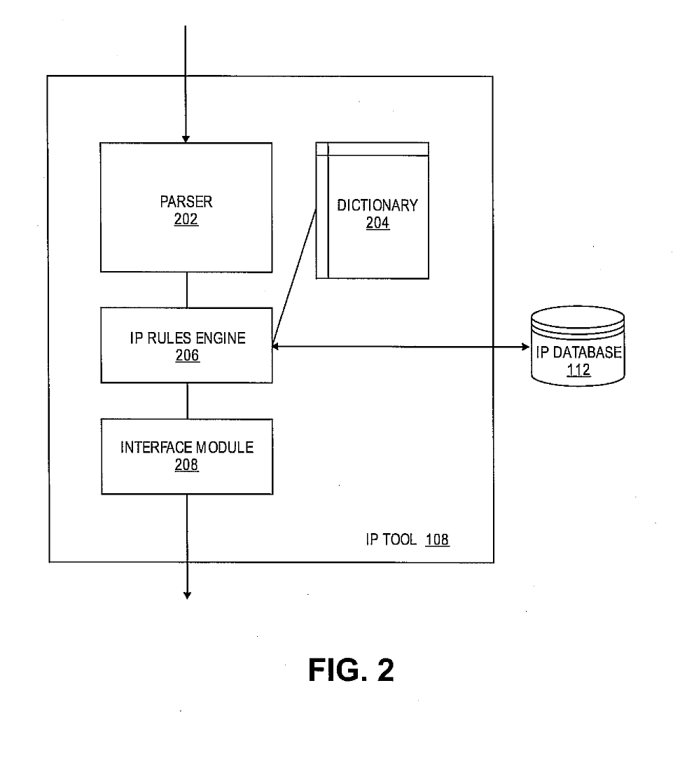

In addition to the standard tools, system 100 may also include IP tool 108. IP tool 108 may be a tool that is separate from build system 106, or may be integrated into build system 108. IP tool 108 is a tool identifies and tracks intellectual property aspects in source code. IP tool 108 may be implemented as software that is configured to parse the source code to identify intellectual property aspects. For example, in some embodiments, IP tool 108 is configured to search for various key terms, such as “copyright, ®, trademark, ™, patents, GPL, GNU, LGPL, and the like. Of course, one skilled in the art will recognize IP tool 108 may be configured to identify IP features based on a wide variety of terms. IP tool 108 is further described with reference to FIG. 2.

In addition, IP tool 108 may be configured to track other sensitive features in software. For example, IP tool 108 may be configured to identify the use of cryptography and encryption in software. Cryptography and encryption often have special IP features or other limitations. For example, export controls often apply to software containing cryptography or encryption algorithms. In addition, encryption and cryptography are often subject to patents, copyrights, etc. As another example, IP tool 108 may be configured to identify the use of various types of files or compression. File types and compression are likewise frequently subject to various limitations and licensing concerns.

Software management service 110 serves as the interface for distributing the software managed by system 100. In order to distribute software, software management service 110 bundles the software in compiled form and provides it in a package that easily transportable. For example, software management service 110 may provide software in the form of RPM, deb, tgz, msi, exe, etc. files. Software management service 110 may also provide an installer program. As shown in FIG. 1, software management service 110 is coupled to a network 114 and enables clients 116 to download packages of software over network 114.

IP database 112 serves as a database for the IP features identified by IP tool 108. In some embodiments, IP database 112 is configured to track IP features at various levels of code. For example, IP database 112 may include data structures to track IP features by files, by package, by IP feature, etc.

FIG. 2 illustrates an exemplary architecture of IP tool 108. As shown, IP tool 108 may comprise a parser 202, a dictionary 204, an IP rules engine 206, and an interface module 108. These components will now be briefly described.

Parser 202 may be software that is configured to parse the source code in code repository 104 and converts it to a data structure that can be analyzed by IP rules engine 206. Parser 202 may be implemented using well known software for various programming languages used in the source code files contained in code repository 104.

Dictionary 204 provides a database that lists the key terms of interest to IP tool 108. For example, in some embodiments, dictionary 204 contains terms, such as, GPU, GNU, LGPL, copyright, ®, trademark, ™, patent, BSD, and the like. One skilled in the art will recognize that dictionary 204 may contain a wide variety of terms to assist in identifying intellectual aspects of any source code.

IP rules engine 206 analyzes the output of parser 202 and compares it to dictionary 204. IP rules engine 206 may be implemented as software that includes various algorithms to identify IP features in a source code file. For example, as noted, based on the key terms IP rules 206 may flag a source code file if it contains one or more of the key terms. As IP rules engine 206 finds key terms in the source code file it creates a record of the IP feature in IP database 112.

In addition, IP rules engine 206 may be configured to recognize other features that may be associated with an IP feature. For example, IP rules engine 206 may be configured to recognize names of individuals and companies included as comment text in the source code. IP rules engine 206 may also be configured to recognize contact information, such as email addresses, website addresses, mailing addresses, phone numbers, etc., that may also be included in the source code file as comment text. One skilled in the art will recognize that IP rules engine 206 may implement a wide variety of rules to identify the various IP features present in a source code file.

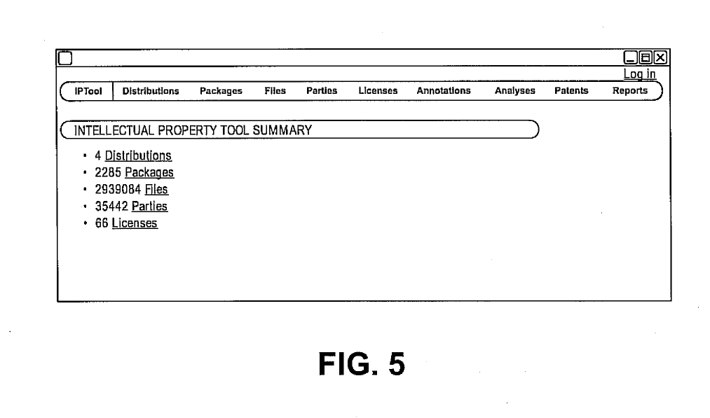

Interface module 108 serves as a communications interface for IP tool 108. For example, users of software management service 110 may be permitted access to interface module 108. Accordingly, interface module 108 may provide a web interface that allows the users to query and browse for IP features in various ways. FIGS. 5-11 provide exemplary screen shots that may be presented by interface module 108.

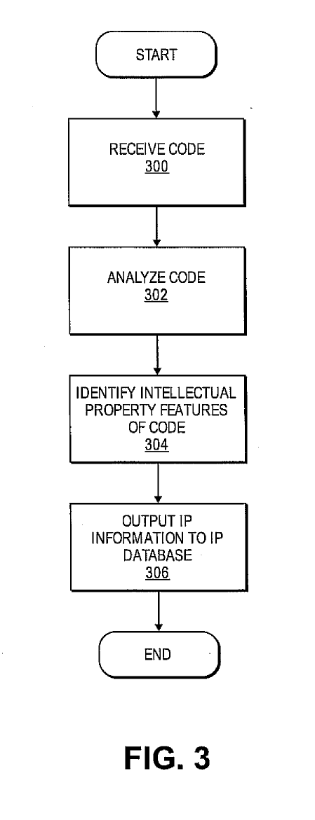

FIG. 3 illustrates an exemplary process flow for tracking IP features in open source software. For purposes of explanation, the process describes the use IP tool 108 to track and audit IP features for a package of open source software, such as a LINUX distribution. However, one skilled in the art will recognize that embodiments of the present invention may apply to other programs and applications.

In stage 300, IP tool 108 receives source code for analysis. In some embodiments, IP tool 108 receives source code for analysis when a source code file is updated by version control system 102. Version control system 102 may be configured to automatically submit each new version to IP tool 108. Alternatively, version control system 102 may be manually commanded to submit a source code file for analysis, for example, by a developer or other type of user.

In other embodiments, IP tool 108 receives source code for analysis when a package or distribution is being built. In this scenario, build system 106 as part of its processes retrieves the source code for a package from code repository 104 and passes them to IP tool 108. IP tool 108 may then be triggered to perform its analysis of this source code.

In stage 302, IP tool 108 analyzes the source code to identify IP features of the code. In particular, parser 202 progresses through the source code and provides its output to IP rules engine 204. Alternatively, parser 202 may first query IP database 112 to determine if a specific source code file has already been analyzed. If so, then parser 202 may then stop its processing and pass the results to IP rules engine 204.

In stage 304, IP rules engine 204 receives the output of parser 202 and identifies the presence of IP features. For example, IP rules engine 204 may refer to dictionary 204 to identify IP features in the code.

In stage 306, IP rules engine 204 records its findings in IP database 112. In general, IP rules engine 204 may index its findings based on individual file names of the source code to ensure a high level of granularity. However, IP rules engine 204 may also record other data, such as which package the file is associated. A user or developer may then view the IP features found according to various views, for example, as shown in FIGS. 5-11.

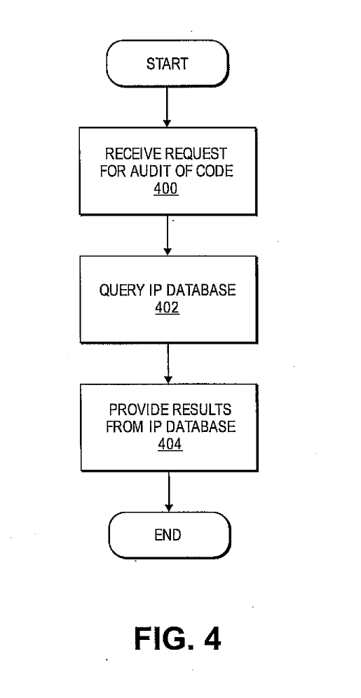

FIG. 4 illustrates a general process flow for auditing a package of open source software for intellectual property features. In stage 400, build system 106 receives a request to build a package.

In stage 402, build system 106 provides a listing of files or other packages that are subject to the current build. This triggers IP tool 108 to query IP database 112 for IP features in these files or other packages in the requested package.

In stage 404, IP tool 108 then provides an output reporting the IP features that are included in the package. IP tool 108 may provide this output in various forms and may sort the IP features according to various criteria. For example, IP tool 108 may provide its results as a meta-data file that accompanies the requested package. Alternatively, IP tool 108 may provide its results by providing links to one or more web pages that are accessible via software management service 110.

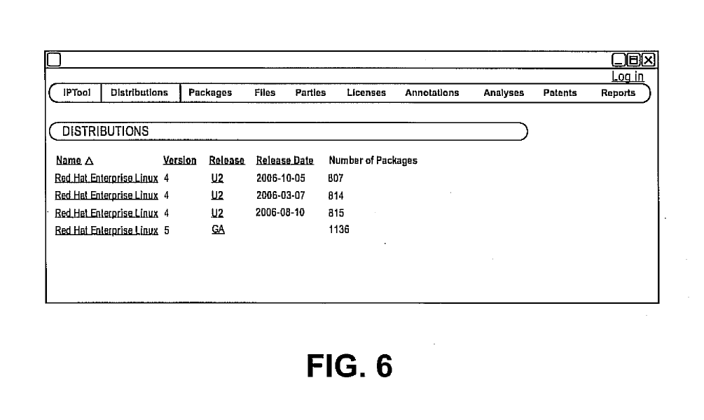

FIGS. 5-11 illustrate various screenshots of web pages that may be used to report IP features of source code in various forms. For example, FIG. 5 illustrates a summary page showing a catalog of the recent analyses performed by IP tool 108. FIG. 6 illustrates distributions that have been analyzed by IP tool 108. As shown in FIG. 6, the user may then navigate to a particular distribution for further information.

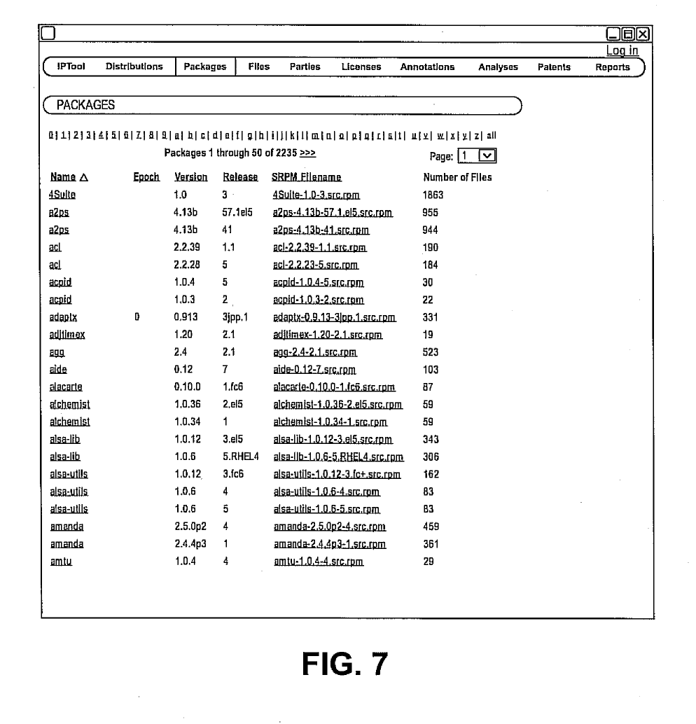

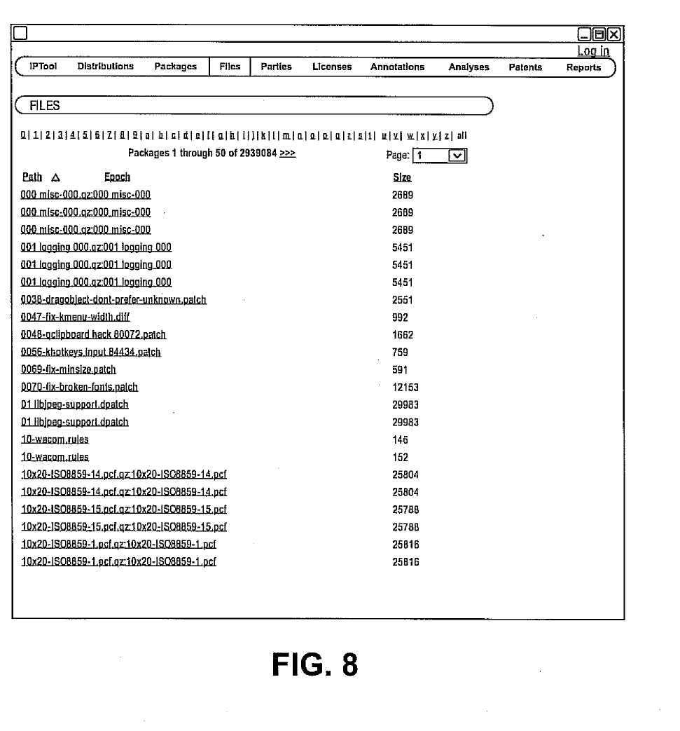

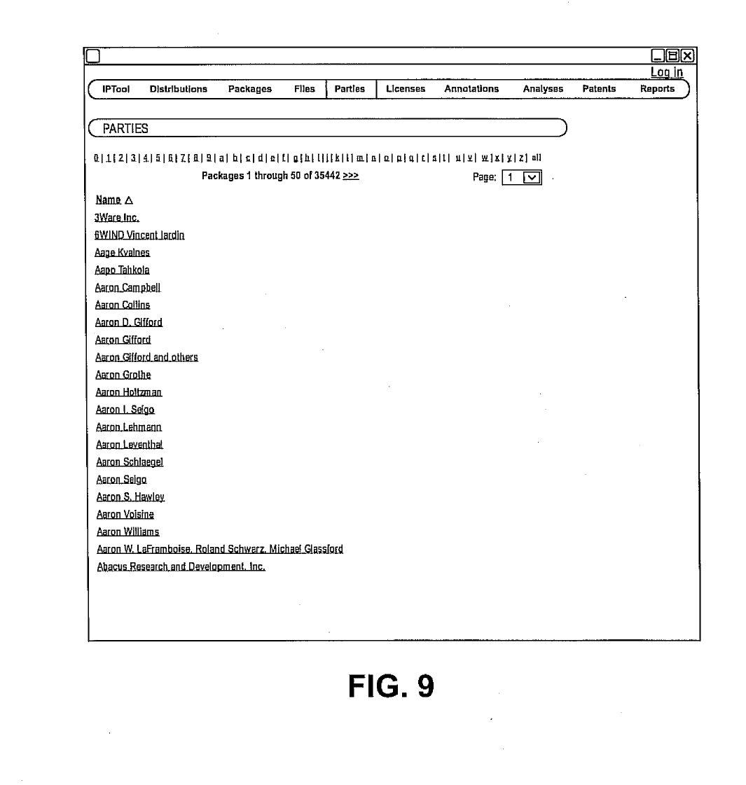

FIG. 7 illustrates an exemplary listing of packages that have been analyzed by IP tool 108. FIG. 8 illustrates an exemplary listing of source code files that have been analyzed by IP tool 108. FIG. 9 illustrates an exemplary listing of parties that have been found by IP tool 108 over the course of its analyses. The user may then select a specific party and be shown various files or packages in which that party is named.

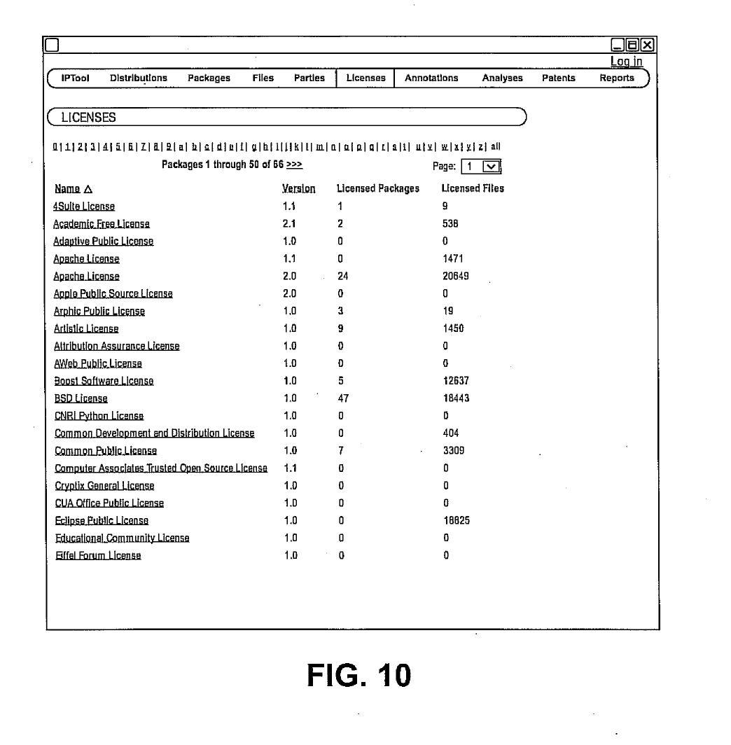

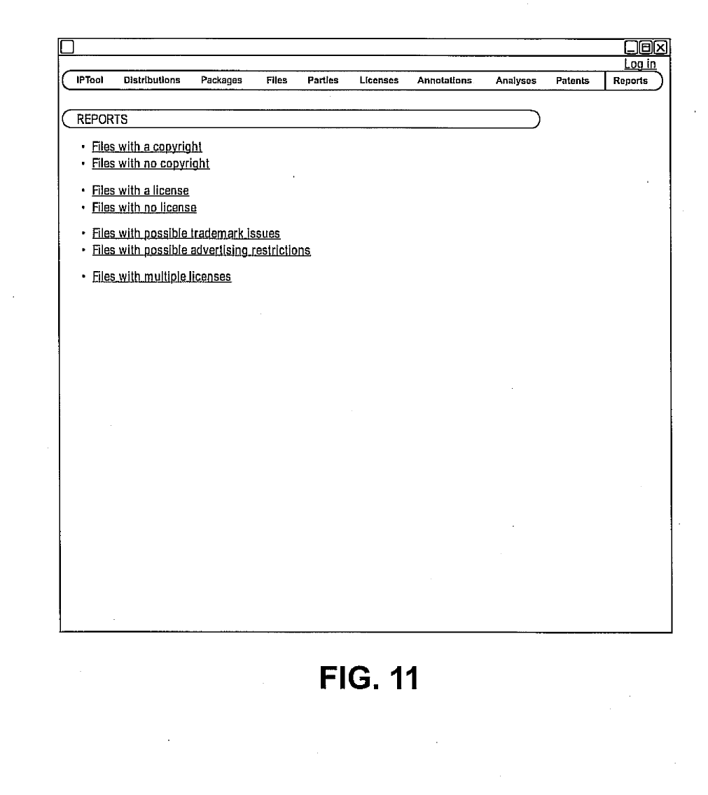

FIG. 10 illustrates an exemplary listing of licenses that have been found by IP tool over the course of its analyses. The user may then select a specific license and be shown various files or packages that are subject to that license. FIG. 11 illustrates an exemplary listing that allows the user to select files or packages based on a type of IP features, such as copyright, trademark, etc. Of course one skilled in the art will recognize that IP features may be presented in a wide variety of ways and that the screen shots provided in FIGS. 5-11 are merely exemplary.

Other embodiments of the invention will be apparent to those skilled in the art from consideration of the specification and practice of the invention disclosed herein. For example, in addition to indicating the various IP features present in the software, embodiments of the present invention may provide links or information about the IP features. In particular, upon identifying an IP feature, the IP tool may be configured to retrieve a website or text of the IP feature and store this information in the IP database. Such information may include, for example, the text of a license agreement, a trademark registration, text of a patent, etc. Other related information may also be retrieved by the IP tool or other component. It is intended that the specification and examples be considered as exemplary only, with a true scope and spirit of the invention being indicated by the following claims.

What is claimed is:

1. A method for tracking intellectual property features of software, said method comprising:
receiving a file of source code;
identifying intellectual property features indicated in text of the source code; and
recording, for each file of the source code, the identified intellectual property features in the text of the source code.

2. The method of claim 1, wherein receiving the file of source code comprises receiving the file of source code from a version control system.

3. The method of claim 1, wherein receiving the file of source code comprises receiving the file of source code as the file after the file has been updated in a version control system.

4. The method of claim 1, wherein identifying intellectual property features comprises parsing text in the source code and searching for key terms from a dictionary.

5. The method of claim 1, wherein identifying intellectual property features comprises identifying a type of license indicated in the source code.

6. The method of claim 1, wherein identifying intellectual property features comprises identifying a copyright indicated in the source code.

7. The method of claim 17 wherein identifying intellectual property features comprises identifying a trademark indicated in the source code.

8. The method of claim 1, wherein identifying intellectual property features comprises identifying a patent indicated in the source code.

9. The method of claim 1, wherein identifying intellectual property features comprises identifying an author of the source code.

10. The method of claim 1, further comprising:
determining at least one package to which the file of source code is included; and
recording the intellectual property feature found in the file of source code as part of the at least one package.

11. The method of claim 1, further comprising:
determining when the file of source code lacks at least one intellectual property feature; and
flagging the file of source code when it lacks at least one intellectual property feature.

12. An apparatus comprising means configured to perform the method of claim 1.

13. A computer readable medium comprising computer executable code for performing the method of claim 1.

14. A method for auditing intellectual property features in a distribution of software, said method comprising:
receiving a request to build the distribution of software;
determining files of source code that are to be included in the distribution of software;
identifying intellectual property features indicated in the files of source code; and
providing an output that indicates the intellectual property features found in the files of source code included in the package.

15. The method of claim 14, wherein identifying intellectual property features indicated in the source code comprises:
retrieving the source code from a code repository;
parsing text in the source code; and
identifying terms that indicate intellectual property features based on the text in the source code.

16. The method of claim 14, wherein identifying intellectual property features in the source code comprises:
identifying names of files of source code included in the package;
querying a database of intellectual property features based on the names of the files of source code; and
determining intellectual property features in the source code based on results of the query.

17. The method of claim 14, farther comprising:
identifying when at least one file of source code in the distribution that lacks at least one intellectual property feature; and
flagging the file of source code when it lacks at least one intellectual property feature.

18. The method of claim 14, further comprising:
identifying at least one file of source code in the distribution lacks at least one intellectual property feature; and
providing a notification when at least one file of source code in the distribution lacks at least one intellectual property feature.

19. An apparatus comprising means configured to perform the method of claim 14.

20. A computer readable medium comprising computer executable code for performing the method of claim 14.

21. A system configured to track and audit intellectual property features in software, said system comprising:
a version control system configured to manage versions of files of source code submitted to the system;
a build system configured to build distributions of software based on the source code submitted to the system; and
an intellectual property tool configured to analyze source code submitted to the system, identify intellectual property features included in each file of source code, and audit distributions of software based on the identified intellectual property features included in the files of source code comprising the distributions.
